(19) United States
(12) Patent Application Publication
(10) Pub. No.: US 2002/0102131 A1
(43) Pub. Date: Aug. 1, 2002

(54) Connector for sheet piles

(76) Inventor: Georg Wall, Munich (DE)

Correspondence Address: DAVIS & BUJOLD, P.L.L.C., 500 NORTH COMMERCIAL STREET, FOURTH FLOOR, MANCHESTER, NH, 03101, US

(21) Appl. No.: 09/974,188

(22) Filed: Oct. 10, 2001

(30) Foreign Application Priority Data
Oct. 11, 2000 (DE) 200 17 445.2

(51) Int. Cl. F16D 1/00; B25G 3/02

(52) U.S. Cl. 403/363

(57) ABSTRACT

The connector (1) has a central bridge element (2) which is part of at least one claw (8, 9) of a C-shaped cross-section, whose jaws (10, 11) point in opposite directions. Provided on at least one of the longitudinal edges of the central bridge element (2) is a connector block (13, 13′) which has a neck section (14) and a head section (15).

### FIELD OF THE INVENTION

The invention relates to a connector for sheet piles.

### BACKGROUND OF THE INVENTION

Such connectors serve to connect piles of sheets which extend relative to one other forming an angle. Examples of such connectors can be inferred from German Patent Application No. DE-A1-39-97-348. They serve for attachment to so-called Larssen sheet piles or sheet piles of the head-claw type.

The problem on which the invention is based is to outline a connector which can be used in several ways, especially for different kinds of sheet piles.

SUMMARY OF THE INVENTION

Accordingly, the connector has a central bridge element from the two longitudinal edges of which extend, in the same direction, two hooked strips so as to form together, with the ridge element, a claw of C-shaped cross-section with one open jaw. A connector block has a neck and a head part which extends from at least one of the longitudinal edges of the central bridge element as a continuation thereof.

Two C-shaped claws are preferably provided which extend with inverse symmetry relative to the bridge element and whose jaws point in opposite directions perpendicularly to the bridge element. The cross-section of the connector resembles a puzzle piece or a stylized manikin.

The inner and outer outlines of the cross-section of the connector are obtained by a combination of arcs.

### BRIEF DESCRIPTION OF THE DRAWINGS

The invention is explained in detail in embodiments with reference to the drawings wherein;

FIG. 1 is a cross-section through a connector according to the invention having one-C-shaped claw;

FIG. 2 is a cross-section through a connector according to the invention having two C-shaped claws; and

FIG. 3 is a cross-section through a welded corner designed as part of a connector according to FIG. 1.

### DETAILED DESCRIPTION OF THE INVENTION

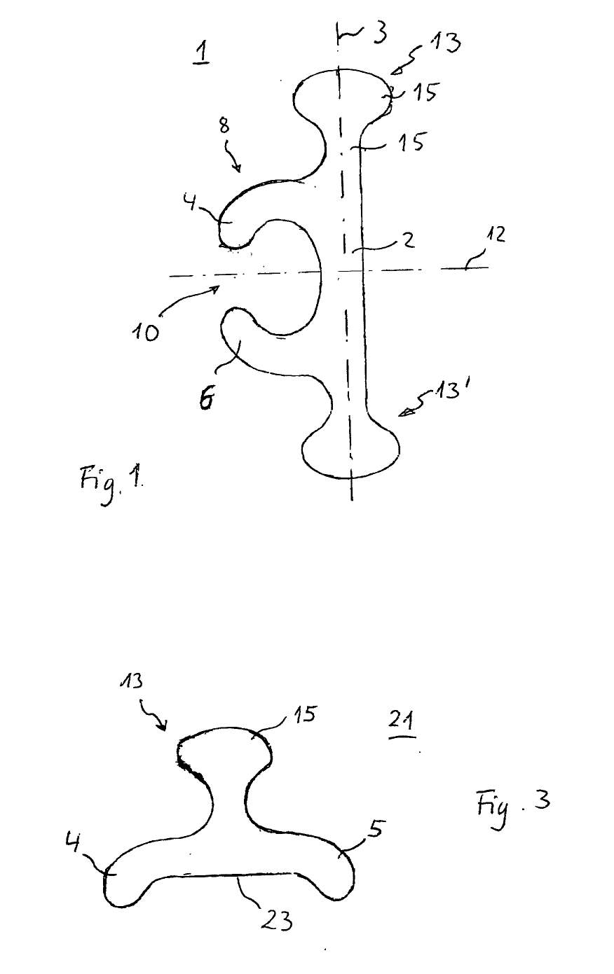

The connector 1, according to FIG. 1, has a central bridge element 2, a median plane of which is designated with 3 and to whose upper and lower longitudinal edges two hooked strips 4 and 6 attach themselves. The hooked strips 4 and 6 form, together with the central bridge element 2, one claw 8 of C-shaped cross-section with an open jaw 10. The claw 8 is divided, by a transverse plane 12 which extends perpendicularly to the median plane 3 and extends approximately through the median line of the central bridge element 2, into two inversely symmetrical halves. A connector block 13 and 13′ is respectively provided on both longitudinal edges of the central element 2, as a continuation, each having a relatively narrow neck section 14 and attaching itself thereto a wider head section 15 of almost elliptical cross-section.

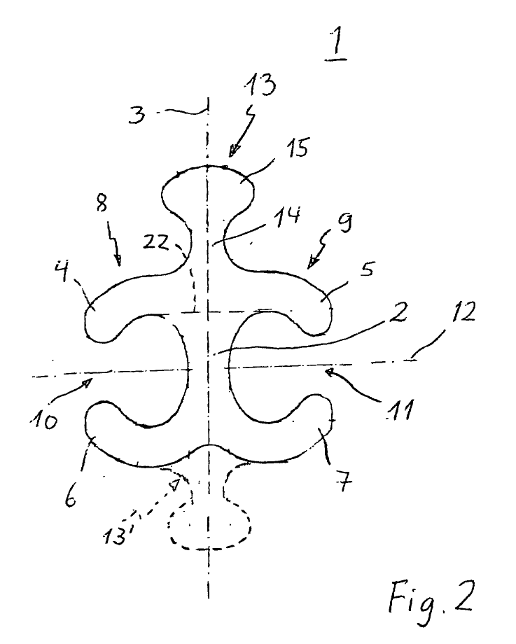

According to FIG. 2, the connector 1 has, in turn, a central bridge element 2 upon the upper and lower longitudinal edges of which respectively extend two hooked strips 4 and 5 and 6 and 7 inversely symmetrical relative to the median plane 3 of the bridge element 2. The hooked strips 4 and 6 and 5 and 7 together with the central bridge element 2 form two claws 8 and 9 of C-shaped cross-section each having one open jaw 10 and 11, respectively. The claws 8 and 9 are divided, by a transverse plane 12 which extend perpendicularly upon the median plane 3 and extends approximately through the median line of the central bridge element 2, into two inversely symmetrical halves. The jaws 10 and 11 face in opposite directions. In the Figure, a connector block 13 is provided on the upper longitudinal edge of the central bridge element 2, as a continuation thereof, which has a relatively narrow neck section 14 which attaches itself to a wider head section 15 of almost elliptical shape.

As shown in dotted lines in the drawing, it is possible to provide one other connector block 13′ on the opposite longitudinal edge of the central bridge element 2 which is designed exactly like the connector block 13.

The connectors, according to FIGS. 1 and 2, are shown in a scale approximately of 1:1. It is seen that the connector element 1 according to FIG. 2 can be essentially composed of two elements according to FIG. 1. The connector is inversely symmetrical relative to the median plane 3 and, insofar as two connector blocks 13 and 13′ are provided, also inversely symmetrical relative to the transverse plane. It can also be seen that for both connectors, the outline of the cross-section in the area of the claws and of the connector blocks is obtained practically by a combination of separate circular segments of different radii: the inner outline of the claws in the area facing the bridge element 2 is constructed by a circular segment having a relatively large radius of 20 mm, for example, to which a circular segment of a substantially smaller radius of 8 mm respectively attaches, for example, which delimits the hooked strips 4, 5, 6 and 7. The outer outlines of the hooked strips extend substantially parallel thereto, the strips having a thickness of about 10 mm. A circular segment of relatively small radius of 8 mm, for example, which leads to the next section 14 attached, in turn, to the outer outlines of both hooked strips 4 and 5. The circular segment which delimits the upper part of the head section has then again a large radius of 16 mm, for example The remaining circular segments are selected so that smooth transitions result.

As seen in a direction of the median plane, the connector extends over a distance of about 75 mm; the largest extension of the inner outline of the claws 8 and 9 parallel to the median plane amounts to about 28 to 30 mm, the jaw opening likewise parallel to the median plane amounting to about 15 mm. The thickness of the central bridge element, in the area of the transverse plane 12, is about 10 mm, the thickness of the connector block in the area of the half part 14 is about 8 mm whereas the largest extension of the head section 15 parallel to the transverse plane 12 amounts to about 24 mm. The whole width of the connector, in a direction of the transverse plane 12, is about 60 mm.

Divergences from said measurements are naturally possible. Thus, for example, the cross-section of the inner outline of the claws can flatly be eliminated, etc.

In FIG. 3, a so-called welded corner 21, is shown. The welded corner resembles part of the connector 1 according to FIG. 2, consisting of the connector block 13, the neck and head sections 14 and 15 and the two hooked strips 4 and 5, the attached central bridge 2 is cut off at the height of the tangents on the inner outline of the jaws on the area closest to the neck section 14, that is, almost at the height of the “armpits” of the “manikin”: this is indicated in FIG. 2 by the dotted line 22. A contact surface 23 is thus formed here which, in the construction of a sheet pile wall, is used as welding surface on which the welded corner is welded to an adjoining sheet pile. It is the possible to attach another sheet pile to the head section 15 at a desired angle.

1. Connector (1) for sheet piles having the following features:
one central bridge element (2), from the two longitudinal edges of which extend in the same direction two hooked strips (4, 5) shaped in a manner such that together with the bridge element there results a claw (8) of C-shaped cross-section having one open jay (10); and
at least from one of the longitudinal edges of said central bridge element (2) extends as continuation thereof a connector block (13, 13′) which has one neck and one head section (14 and 15) respectively.

2. Connector according to claim 1, characterized in that from each of the two longitudinal edges of said central bridge element (2) extends inversely symmetrically one hooked strip (4, 5: 6, 7) so that together with said bridge element (2) there result two claws (8, 9) of C-shaped cross-section having each one open jaw (10, 11) and the jaws point in opposite directions perpendicularly to said bridge element (2).

3. Connector according to claim 1 or 2, characterized in that said hooked strips (4, 5, 6 7) are inversely symmetrical relative to a transverse plane (12) which stands perpendicularly upon the median plane (3) of said central bridge element (2) and cuts said central bridge element approximately in the central point thereof.

4. Connector according to claim 1 or 2, characterized in that the width of said jaw openings (10, 11) approximately corresponds to half of the largest extension of the inner outline of said claws (8, 9).

5. Connector according to any one of the preceding claims, characterized in that the outline of the cross-section of said connector (1) is obtained in the area of said claws and of the connector blocks approximately by a combination of arcs.

6. Connector according to any one of the preceding claims, characterized in that the head part (15) of said connector block (13, 13′) is approximately oval in cross-section.

7. Connector according to any one of the preceding claims, characterized in that a connector block (13, 13′) attaches itself to both sides of said central bridge element (2).

8. Connector according to any one of the preceding claims, characterized in that the total length of neck and head parts (14, 15) seen in cross-section corresponds to about half the length of one claw (8, 9).
